(19) United States
(12) Patent Application Publication
(10) Pub. No.: US 2003/0236731 A1
(43) Pub. Date: Dec. 25, 2003

(54) Global employee record

(75) Inventors: Doris Landaeta, Southbury, CT (US); Cynthia Gaffney, Sandy Hook, CT (US); Anne Mesereau, Stratford, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(73) Assignee: Transcentive, Inc.

(21) Appl. No.: 10/439,488

(22) Filed: May 16, 2003

Related U.S. Application Data
(60) Provisional application No. 60/381,502, filed on May 17, 2002.

(51) Int. Cl. G06F 17/60

(52) U.S. Cl. 705/36

(57) ABSTRACT

A system and method are presented for storing and managing information in equity and performance compensation plans. The method includes storing information records including participants in the compensation plans and their residency history over participant-specified time periods, one or more companies sponsoring one or more compensation plans, and jurisdictional requirements and restrictions applicable to participants, companies and compensation plans. The company data includes company-imposed requirements and restrictions of the plan for granting, vesting and exercising options. The jurisdictional data includes a history of one or more jurisdictional requirements over jurisdictionally-specified time periods. In response to a triggering event, the method includes retrieving participant, compensation and jurisdictional information records corresponding to the trigger, comparing portions of the participant's residency history and the jurisdictional history, and satisfying the triggering event by complying with company and jurisdictionally imposed requirements and restrictions in accordance with applicable time periods.

### CROSS-REFERENCE TO RELATED APPLICATIONS

This patent application claims the benefit of U.S. Provisional Patent Application Serial No. 60/381,502, entitled “SYSTEM AND METHOD FOR STORING AND MANAGING A RECORD OF A GLOBAL EMPLOYEE” that was filed on May 17, 2002, and is related to commonly owned U.S. patent application Ser. No. ______ (attorney docket 102206-200) which was filed concurrently herewith. The disclosure of these patent documents are incorporated by reference in their entireties as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to computer processing systems for equity and performance compensation plans and, more particularly, to a system and method for storing and managing information in equity and performance compensation plans.

2. Description of Prior Art

For many years publicly-owned companies have provided compensation to employees in the form of options to purchase shares of company stock at discounts from market price, as performance based incentives and restricted cash bonuses. Performance based and non-performance based equity awards are attractive to both the employee and company for many reasons. For example, employees prefer stock options since the option is a form of deferred payment that provides certain tax benefits and allows the employee to control the time that the income is accrued. Companies find options attractive since the opportunity to buy stock in the company provides additional incentives to employees to work harder for the benefit of the company (e.g., and increase the value of the company in trading markets).

As more and more companies and employees within particular companies select compensation in the form of performance awards and stock options, computer processing systems that manage such equity compensation plans have become increasingly complex. For proper management of equity and performance compensation plans, an equity and performance compensation system must individually delineate (e.g., for each employee and plan) such information as option grants, vesting periods, exercise methods and dates, and expiration dates.

Equity and performance compensation plans and systems that manage such plans are also complicated when companies and employees within the companies reside in more than one country (e.g., differing jurisdiction for tax and/or security regulation). Often, legal requirements (e.g., ownership, tax, and other reporting requirements) vary from one jurisdiction to the next. The inventors of the present invention have found a number of deficiencies in the ability of conventional equity and performance compensation systems to handle such complexities.

Accordingly, the inventors have realized that a need exists for an improved equity and performance compensation system that employs an efficient and reliable method for storing and managing information in equity and performance compensation plans such as, for example, biographical information of employees participating in the plans.

### OBJECTS OF THE INVENTION

Accordingly, it is an object of the present invention to provide an improved data processing system and method for storing and managing information within equity and performance compensation plans.

It is another object of this invention to provide a time sensitive system and method for equity and performance compensation plans that provides visibility to movement of participants within multiple jurisdictions and to employment status of the participants during periods of interest.

Further objects of this invention will become more apparent from a consideration of the drawings and ensuing description.

### SUMMARY OF THE INVENTION

The above and other objects are achieved by a system and method for storing and managing information in equity and performance compensation plans. The method includes storing information records including participants in the compensation plans and their residency history over participant-specified time periods, one or more companies sponsoring one or more compensation plans, and jurisdictional requirements and restrictions applicable to participants, companies and compensation plans. The company data includes company-imposed requirements and restrictions of the plan for granting, vesting and exercising options. The jurisdictional data includes a history of one or more jurisdictional requirements over jurisdictionally-specified time periods. In response to a triggering event, the method includes retrieving participant, compensation and jurisdictional information records corresponding to the trigger, comparing portions of the participant's residency history and the jurisdictional history, and satisfying the triggering event by complying with company and jurisdictionally imposed requirements and restrictions in accordance with applicable time periods.

In one embodiment, the triggering event is a request by a participant to exercise an option and the step of complying includes determining income realized by exercising the option and determining a tax imposed on the realized income by retrieving within the participant's residency history each jurisdiction of residence and time period of residence and retrieving within the jurisdictional history of each retrieved jurisdiction tax rates applicable for the time period of residence.

In a second embodiment, the time period events may be used as a basis of determining future potential impacts of equity and performance compensation plans on company expenses. A “what-if” scenario may be modeled using future assumptions of participant mobility to gauge potential corporate tax deduction as well as projected corporate expenses associated with equity and performance compensation plans. Conversely, time period events may be used to review historical events and transactions with precise accuracy as a result of maintaining the global employee record (e.g., an audit of tax liabilities as a result of all global employee mobility may be required).

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram of a data processing system constructed and operating in accordance with one embodiment of the present invention;

FIGS. 2A-2C depict portions of information records including participant, compensation plan and jurisdictional data, in accordance with one embodiment of the present invention;

FIGS. 3A-3C depict portions of information records of FIGS. 2A-2C in accordance with one embodiment of the present invention;

FIG. 4 is a graphical illustration of movement of a participant and applicable compensation plan events during time periods of interest;

FIG. 5 depicts a participant information record corresponding to the illustration of FIG. 4; and

FIG. 6 depicts a participant residency information report in accordance with one embodiment of the present invention.

In these figures, like structures are assigned like reference numerals, but may not be referenced in the description for all figures.

### DETAILED DESCRIPTION OF THE PREFERRED EMBODIMENTS

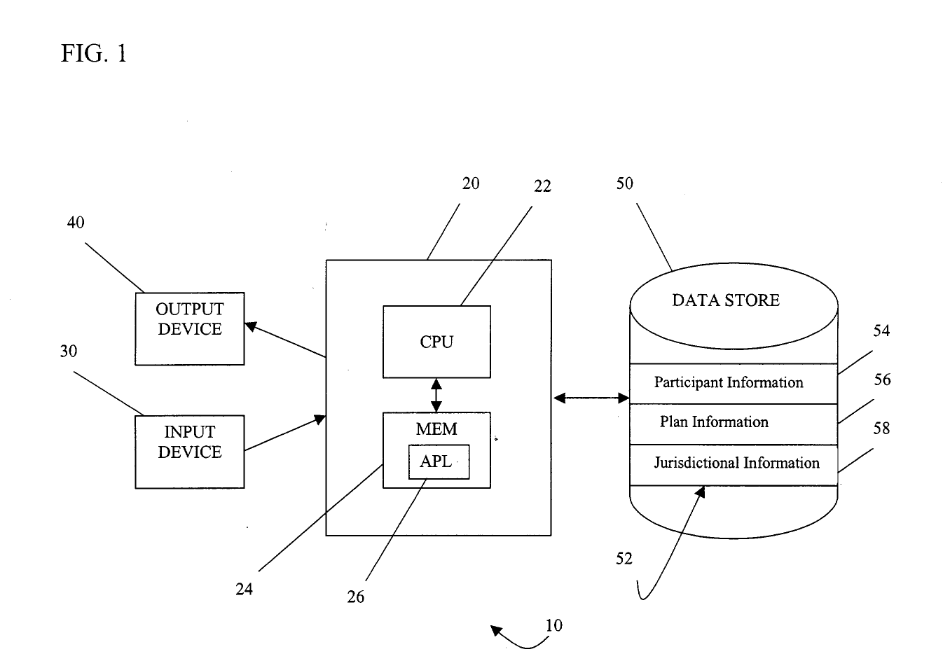

FIG. 1 illustrates a data processing system 10 configured and operating in accordance with one embodiment of the present invention to implement techniques, as described herein, for storing and managing information in equity and performance compensation plans. The system 10 includes a data processor 20 coupled to a data store 50. The data processor 20 includes an input device 30 and an output device 40. The input device 30 includes, for example, a keyboard, mouse, touch-sensitive screen, electronic stylus or other conventional input devices for inputting information to the data processor 20. The output device 40 includes, for example, a display device or monitor, a printer or other conventional output devices for receiving and presenting information to users of the data processor 20. In one embodiment, the data processor 20 includes, for example, a personal computer, work station or portable computing device such as a laptop or tablet computer, personal data assistant (PDA), or the like. In some embodiments, the input device 30, output device 40 and the data processor 20 are incorporated in a single form factor, such as in the aforementioned laptops and PDAs.

The data processor 20 includes a central processing unit (CPU) 22 such as a microprocessor and a memory device 24 having, for example, ROM, RAM and/or non-volatile memory components for storing application programming logic (APL) 26, variables and/or parameters used during operating of the CPU 22. As shown in FIG. 1, the data processor 20 is coupled to the data store 50. The data store 50 stores information, shown generally at 52, utilized during operation of the equity and performance compensation plans. It should be appreciated that the data store 50 may be any type of storage device such as, for example, a magnetic, optical or other non-volatile device for storing digital data. While shown in FIG. 1 as a system standalone system, it should be appreciated that in other implementations of the present invention, the data processing system 10 includes a plurality of client computer systems coupled to the data store 50 over a communication network such as the Internet, an intranet or extranet by one or more server systems.

In accordance with the present invention, the data processing system 10 manages operations of equity and performance compensation plans such as, for example, individual stock option plans for one or more companies. Generally speaking, the data processing system 10 stores and manages information of participating individuals having present and/or future rights to options of select stock and of a plurality of distinct option plans that dictate an individual's rights in exercising their options. Preferably, the data processing system 10 responds to both time and event triggers. For example, at predetermined periods of time, the data processor 20 receives updated information that it stores within the data store 50. The updated information may pertain to changes in equity plans managed by the data processing system 10 and/or participants of the various plans. Additionally, the data processor 20 receives updated information from completion of tasks such as, for example, an exercise of an option by one of the plan participants (e.g., an employee).

As used herein, the following terms have the following meanings.

1. Option Grant. An option is a right to purchase a predetermined number of shares of a security (e.g., company stock) at a predetermined price (e.g., a strike price). Options are granted to eligible employees on a given date (e.g., a grant date). The options have a limited term and, if not exercised, expire at the end of the term (e.g., at a predetermined expiration date).

2. Performance Award. A performance award is a right to purchase a predetermined number of shares of a security (e.g., company stock) at a predetermined price or at a price that is tied to a market index (e.g. the exercise price is tied to the Dow Jones Industrial Average). Awards are granted to eligible employees on a given date (e.g., a grant date). The options have a limited term, are vested and eligible for exercise upon the satisfaction of a performance measure (e.g., the stock price reaches a predetermined value) and expire at the end of the term (e.g., at a predetermined expiration date).

3. Vesting Period. Granted options are exercisable at the completion of a predetermined time period (e.g., a vesting period). Typically a vesting period is at least one year after the grant date of the option.

4. Exercise Methods. An option is typically exercised by paying a purchase price (e.g., the strike price) for up to the number of shares granted in the option such that the person exercising the option owns the underlying security. Option exercise methods typically include a stock swap, participant's cash payment, and an effectively immediate sale of the underlying security after exercise to pay the strike price. The later method is generally referred to as a “cashless” exercise method because the participant (e.g., employee exercising the option) does not actually buy and sell the stock. Rather, in the cashless method, the participant receives what would have been disbursed from a buy-sell transaction (e.g., the fair market value of the security less the strike price). For transactions that include multi-jurisdictional issues (e.g., a participant residing in one or more jurisdictions during a time period from a grant to the exercise), the system 10 evaluates and provides reporting for the implementation, as needed, of one or more jurisdiction-specific rules such as, for example, tax rates.

5. Income. Upon exercise, participants realize as compensation the spread between an option grant (or performance award) price and an exercise price (e.g., a fair market value on exercise date). In some jurisdictions the realized compensation is taxable, ordinary income and in others it is not taxable. It should be appreciated that the system 10 supports such multi-jurisdictional rules.

In accordance with one aspect of the present invention, the data processor 20 and the data store 50 cooperate to store and manage information 52 including participant information 54, equity and performance compensation plan information 56 and jurisdictional information 58. The participant information 54 includes, for example, individual biographic data of employees within one or more companies utilizing the data processing system 10 for equity and performance compensation plan monitoring. The compensation plan information 56 includes, for example, company option plan requirements, current stock prices, and account information. The jurisdictional information 58 includes, for example, current tax and reporting requirements. As shown in FIGS. 2A-2C, it should be appreciated that the data store 50 may store the aforementioned information 52 as individual record types (e.g., in separate tables), one each for the participant information 54 (FIG. 2A), compensation plan information 56 (FIG. 2B) and jurisdictional information 58 (FIG. 2C). Alternatively, one or more of the record types may be incorporated within a portion of one data record stored in the data store 50. It should also be appreciated that, in one embodiment, the data store 50 is comprised of a plurality of relational data base tables including the aforementioned information 52.

As illustrated in FIG. 2A, the participant information 54 includes biographical information of persons (e.g., employees) participating in one or more equity and performance compensation plans monitored by the system 10. In one embodiment, the participant information 54 includes the participant's name, address and contact information (e.g., telephone numbers). In accordance with the present invention, the participant information 54 includes a residency history 60 of the participant. For example, the residency history 60 includes a plurality of prior places of residence (e.g., residence 1 to residence N) and dates in which the participant resided at each of the prior places of residence (e.g., a beginning or “FROM” date and an ending or “TO” date). As described below, the inventors have found that an accurate residency history is important to ensure compliance to various jurisdictional requirements (e.g., differing tax and reporting requirements).

In one embodiment, the residency history 60 includes an indication of employment status of the participant during periods of time defined, for example, within each of his/her places of residency. An accurate indication of an employee's employment status during to one or more vesting periods may be needed when determining whether the employee may exercise an option in accordance with, for example, company-defined rules of its plan. FIG. 3A depicts exemplary participant information 54′ for a participant named “JOHN DOE.” Residency history 60′ for Mr. Doe includes an employment status field 64 having values of, for example, “active” indicating that Mr. Doe was an active employee of the company during a first time period (e.g., from Apr. 1, 1972 through Jul. 7, 1997), not an employee (e.g., inactive) during a second time period (e.g., from Jul. 8, 1997 through Sep. 8, 1998) and an active employee during a third time period (e.g., from Sep. 9, 1998 through the current date). As illustrated in FIG. 3A, a current date may be represented by a label such as, for example, a value that would generally exceed acceptable dates such as the value “99/99/9999”. Alternately, the current date may be a null field value (e.g., blank or all zeroes) or an alpha field such as “current”. It should be appreciated that a number of alpha, numeric and alphanumeric values may be coded to equate to a current date.

FIG. 2B illustrates one embodiment of the equity and performance compensation plan information 56. As shown, the compensation plan information 56 includes, for example, a set of company imposed rules regarding equity or performance compensation plan being managed by the data processing system 10. In one embodiment, the company imposed rules may include, for example, restrictions and/or requirements for granting, vesting, and exercising options. One embodiment of the compensation plan information 56′ is illustrated in FIG. 3B. As shown in FIG. 3B, the compensation plan information 56′ may include a description of the plan shown generally at 70, option plan requirements shown generally at 72 and 74, and a current stock price 76.

As shown in FIG. 2C, the jurisdictional information 58 includes a set of country-specific rules regarding equity and performance compensation plans applicable to individuals (e.g., employees) within its jurisdiction. In one embodiment, the country-specific rules include, for example, various requirements and/or restrictions imposed by the country on one or more features of the equity and performance compensation plan. For example, the country may impose requirements and/or restrictions on a grant, vesting or exercise of options within the compensation plan. In accordance with the present invention, the jurisdictional information 58 includes a tax history 62 such as, for example tax rates and brackets, during predetermined time periods (e.g., tax rate & bracket 1 to tax rate & bracket M). The tax history 62 includes effective dates for the tax rates and bracket (e.g., a beginning or “FROM” date and an ending or “TO” date). FIG. 3B illustrates one embodiment of jurisdictional information 58′ wherein the history 62′ of an exemplary tax rate & bracket (e.g., US Federal Income Tax) in a first bracket is shown.

It should be appreciated that perceived advantages of the present invention over conventional equity and performance compensation managing systems includes the addition of a time dimension to previously static residency and jurisdictional information that may have previously only been randomly reflected in the conventional systems. For example, by accurately reflecting an employee's residency and employment status within a number of vesting periods and by comparing this information to jurisdictional information over corresponding time periods, compliance with jurisdictional mandates (e.g., tax and reporting requirements) can be more readily and effectively met.

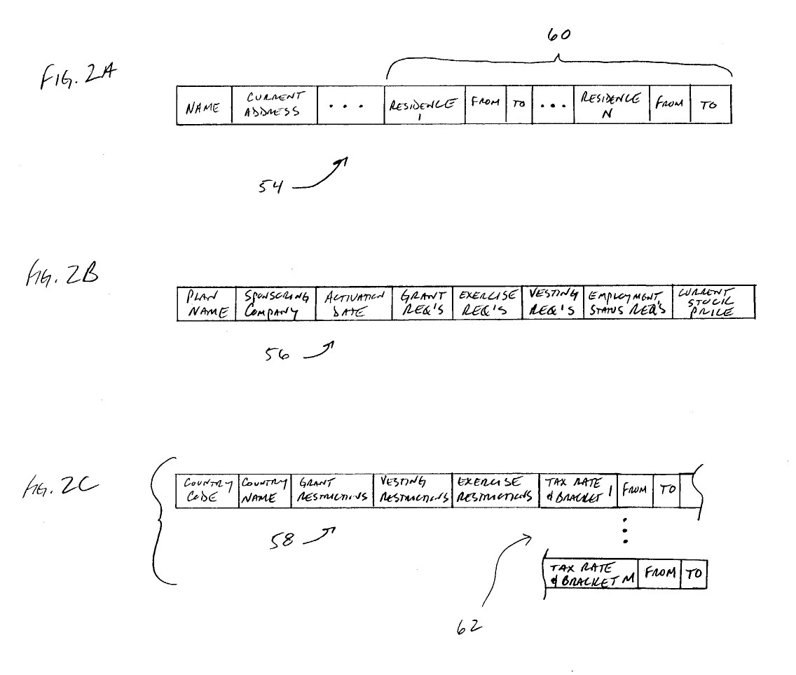

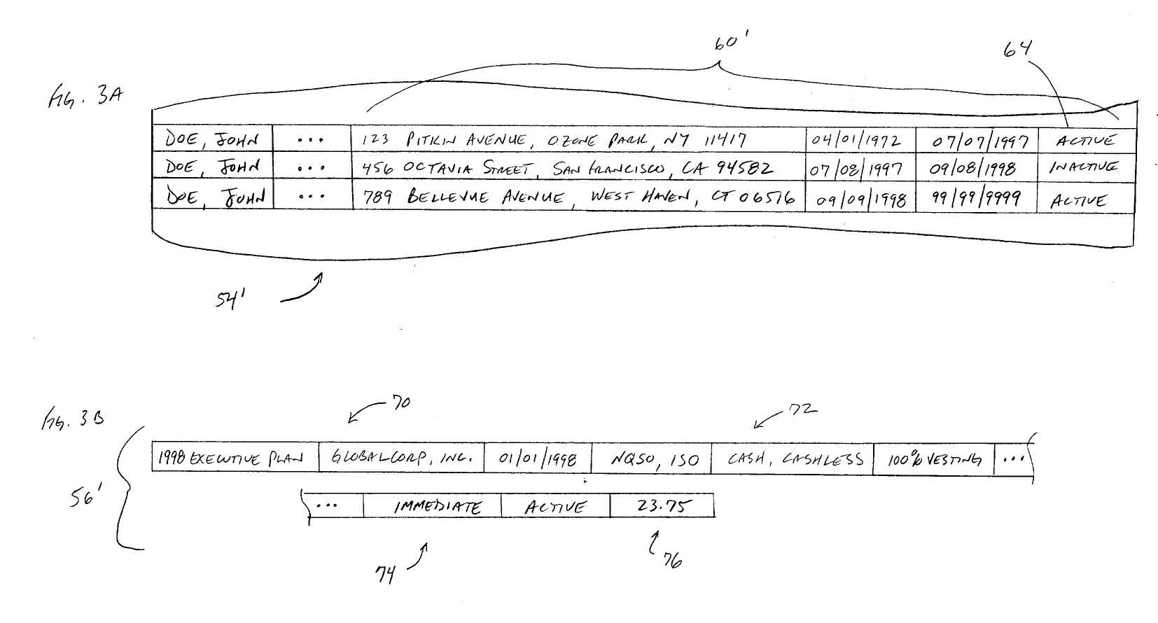

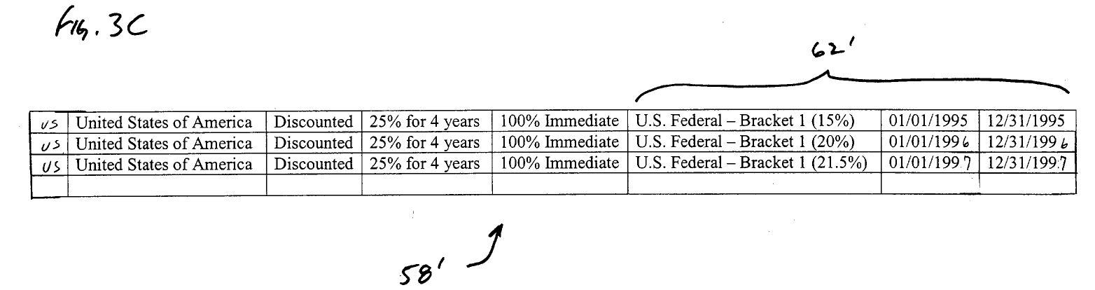

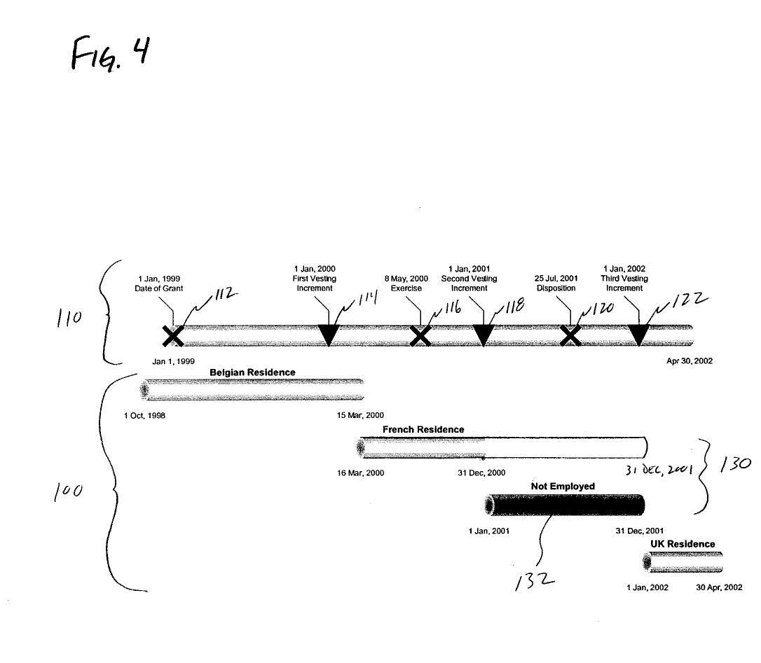

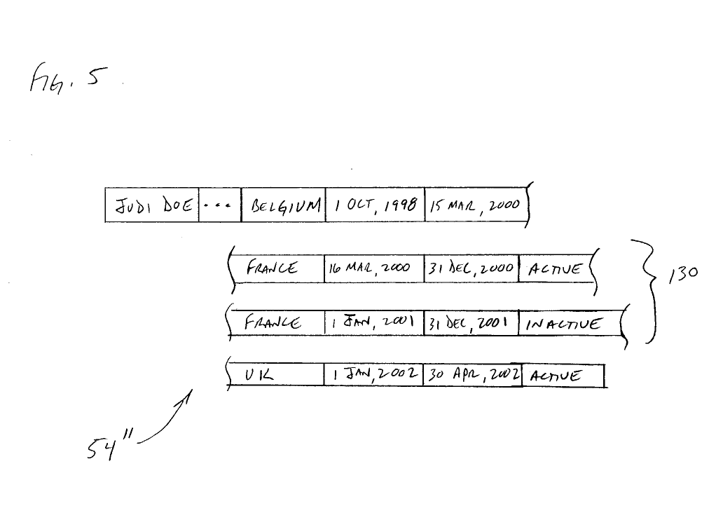

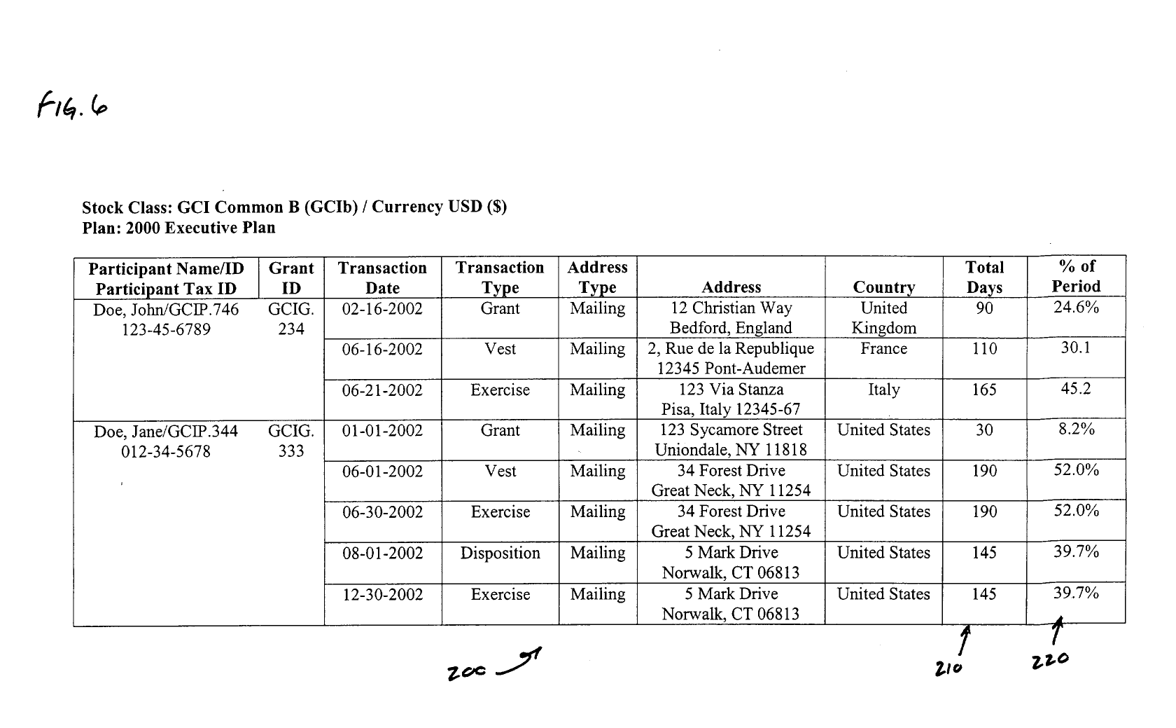

FIG. 4 graphically illustrates movement (shown generally at 100) of an exemplary participating employee, Judi Doe, from a date of an option grant (or performance award) (e.g., on Jan. 1, 1999) to final disposition of an option (e.g., Jul. 25, 2001). The lifetime of the option is illustrated generally at 110 and includes a plurality of milestones 112-122 (e.g., vesting periods and exercise dates). As illustrated in FIG. 4, Ms. Doe resides in Belgium from Oct. 1, 1998 to Mar. 15, 2000, in France from Mar. 16, 2000 to Dec. 31, 2001 and in the UK from Jan. 1, 2002 to Apr. 30, 2002. FIG. 5 depicts a participant information record 54″ corresponding to Ms. Doe. As shown in FIGS. 4 and 5, Ms. Doe's residence history includes time residing in three jurisdictions (e.g., Belgium, France and UK). During at least one period of time while residing in France, shown generally at 130, Ms. Doe was not employed, (e.g., inactive during period 132).

In accordance with the present invention, the system 10 captures Ms. Doe's movement 100 and the lifetime of the option 110 within a participant information record 54 (e.g., record 54″ of FIG. 5), a compensation plan information 56 and jurisdictional information record 58. The data processor 20 retrieves these information records from the data store 50 and provides the information to systems and/or personnel calculating, for example, taxes owed by the participant to one or more governmental agencies within one or more jurisdictions based on taxable events (e.g., grants, vesting, exercise and disposition milestones 112-122).

For example, in response to Judi Doe's request to exercise an option (at Milestone 116), the data processor 20 retrieves Ms. Doe's residency history (e.g., participant information record 54″) and provides the information (e.g., via a report 200 described below) for calculation of taxes owed. In the calculation, the information is evaluated such that determinations are made that Ms. Doe resided in Belgium and France for a period of interest, such residency and/or employment status may be pertinent for determining whether the exercise is allowable in accordance with company imposed rules, and for calculating taxes owed due to the exercise (if allowed). The processor 20 next retrieves the rules of the compensation plan (e.g., compensation plan information 56) and the jurisdictional information for Belgium and France (e.g., jurisdictional information records 58). The plan rules and any jurisdictional rules are compared and the data processor 20 determines whether Ms. Doe's request to exercise the option can be approved. If the exercise is approved, then the data processor 20 calculates the taxes due for each jurisdiction and time period (e.g., tax owed to Belgium and France, if any) and/or provides the report 200 to systems and/or personnel computing taxes owed.

Accordingly, the aforementioned time dimensioned information recording and reporting features of the present invention improve accuracy of compliance to mandates of local jurisdictions and, by maintaining these records within the data store 50 the inventive system 10 is seen to provide historical evidence of tax rates, tax brackets and participant's movement that can be retrieved and included in system reporting. FIG. 6 depicts one embodiment of the aforementioned report 200 for providing the residency information for analysis. In one embodiment, the report 200 includes calculations of the time the participant resided at a particular residence (e.g., a number of days 210 and percentage 220 information).

It should be appreciated that a company may analyze employee residency history records 60 and/or corresponding jurisdictional history records 62 (e.g., via various reports 200) to anticipate expenses and/or deductions associated with its equity and performance compensation plans. Predictions and forecasts (e.g., so called “what-if” scenarios in the art) may allow the company to maximize advantages to itself and/or its employees by providing incentives for employees to take certain actions under the plan to achieve the aforementioned advantages. Additionally, the reports 200 may be used to review historical events and transactions with precise accuracy as a result of maintaining the residency and jurisdictional history records 60 and 62, respectively.

While the inventive system 10 and method for storing and managing information in equity and performance compensation plans has been described and illustrated in connection with preferred embodiments, many variations and modifications, as will be evident to those skilled in this art, may be made without departing from the spirit and scope of the invention. The invention is thus not to be limited to the precise details of methodology or construction set forth above as such variations and modification are intended to be included within the scope of the invention.

What is claimed is:

1. In a data processing system, a method for storing and managing information in equity and performance compensation plans, comprising:
storing information records including data representing participants in the compensation plans and their residency history over participant-specified time periods, data representing one or more companies sponsoring one or more compensation plans, wherein the company data includes company-imposed requirements and restrictions of the plan for granting, vesting and exercising options, and data representing differing jurisdictional requirements and restrictions applicable to participants, companies and compensation plans, wherein the jurisdictional data includes a history of one or more jurisdictional requirements over jurisdictionally-specified time periods; and
in response to a triggering event, retrieving participant, compensation and jurisdictional information records corresponding to the trigger, comparing portions of the participant's residency history and the jurisdictional history, and satisfying the triggering event by complying with company and jurisdictionally imposed requirements and restrictions in accordance with applicable time periods.

2. The method as set forth in claim 1, wherein the triggering event is a request by a participant to exercise an option and wherein the step of complying includes:
determining income realized by exercising the option; and
determining a tax imposed on the realized income by retrieving within the residency history of the participant each jurisdiction of residence and time period of residence, retrieving within the jurisdictional history of each retrieved jurisdiction of residence, tax rates applicable for the time period of residence.

3. A system for storing and managing information in equity and performance compensation plans, comprising:
a data storage device for storing information records including data representing participants in the compensation plans and their residency history over participant-specified time periods, data representing one or more companies sponsoring one or more compensation plans, wherein the company data includes company-imposed requirements and restrictions of the plan for granting, vesting and exercising options, and data representing differing jurisdictional requirements and restrictions applicable to participants, companies and compensation plans, wherein the jurisdictional data includes a history of one or more jurisdictional requirements over jurisdictionally-specified time periods; and
a data processor coupled to the data store, the data processor accessing the data store, in response to a triggering event, and retrieving participant, compensation and jurisdictional information records corresponding to the trigger, comparing portions of the participant's residency history and the jurisdictional history, and satisfying the triggering event by complying with company and jurisdictionally imposed requirements and restrictions in accordance with applicable time periods.
